(19) United States
(12) Patent Application Publication
(10) Pub. No.: US 2022/0212130 A1
(43) Pub. Date: Jul. 7, 2022

(54) Offshore water intake and discharge structures making use of a porous pipe

(71) Applicant: Exotex, Inc., Houston, TX (US)

(72) Inventors: Michael J. Parrella, Katy, TX (US); Nevil R. Ede, Westport, CT (US)

(21) Appl. No.: 17/607,134

(22) PCT Filed: Dec. 17, 2019
(86) PCT No.: PCT/US2019/066913

§ 371 Date: Oct. 28, 2021

Related U.S. Application Data
(60) Provisional application No. 62/780,521, filed on Dec. 17, 2018.

(51) Int. Cl. B01D 29/72; B01D 29/35; B01D 29/11

(52) U.S. Cl. CPC B01D 29/72; E03B 3/04; B01D 29/111; B01D 29/35

(57) ABSTRACT

A porous pipe for use in offshore water intake and discharge systems is provided, which is able to strain and filter water directly within the water body along the length of the pipe. Features of the porous pipe can be designed to optimize performance and flow rates for the particular environment, including the pore distribution and diameter along the pipe, the wall thickness and materials along the pipe; and the placement of piezoelectric devices to vibrate the pipe wall to remove impinged debris from pores.

### CROSS-REFERENCE TO RELATED APPLICATIONS

The present application claims the benefit of U.S. Provisional Application No. 62/780,521 filed Dec. 17, 2018, which is hereby incorporated by reference in its entirety.

### BACKGROUND OF THE INVENTION

Currently, applications requiring large volume flow-rates of water to be transferred between a natural water body, such as a lake or the sea, and process pipework utilize one of a variety of water intake and exhaust structures. Applications typically seen with such large scale structures include process cooling, desalination, and other applications.

Water entering a process is generally filtered to a reliable and consistent standard, typically as clear of particulates and debris as reasonably practicable. FIG. 1A illustrates some examples of current intake structures. Initial water intake maybe through a functional device such as a velocity cap 11, or coarse filter bars 12 placed between 20 mm and 150 mm apart. Intake of debris small enough to pass through a coarse filter may be acceptable depending on the process plant.

Processes with finer tolerances often employ fine mesh screens with openings of between less than 1 mm and 10 mm. Direct filtration of bulk water with such a fine filter is typically avoided to reduce clogging and damage, unless volume flow-rate intake of water is relatively low and regular maintenance can be performed. Fine filters are therefore generally placed downstream of a coarse filter, with the most economical method often being to place both filters together in a forebay 13 with or without active debris removal.

Various methods, such as mechanical rakes and traveling or rotating screens, are currently employed to remove debris that may clog and reduce performance of coarse and fine filters. The practicability of efficiently cleaning a large surface area of filter often requires intake structures that employ a small filter with water at high velocity to achieve a reasonable flow-rate.

The effect of these filtration and maintenance processes on marine organisms and debris located around an intake structure are usually split into two or three categories. Impingement occurs as marine organisms are held against the filters by the velocity of water flowing through the filter. Organisms that are too large to fit through a filter, typically baby and juvenile fish, and too small to swim against the flow may have a survival rate of less than 15% (“An Overview of Seawater Intake Facilities for Seawater Desalination”, Tom Pankratz). The EPA recommends a water velocity of less than 0.5 feet per second towards a filter to reduce impingement. Entrainment is the intake of small marine organisms, such as plankton and fish larvae, through a filter directly into the process pipework. Entrained organisms are assumed to have a 100% mortality rate and represent a maintenance cost due to various methods required to be employed to reduce their growth inside process pipework, such as constant chemical dosing. Entrapment occurs when fine filter screens are located far downstream of coarse filters or an open pipe end intake 13. Organisms cannot swim back against the pipe intake flow and remain in the forebay area, if not entrained or impinged at the fine filter.

The performance of an intake filter is substantially reduced by debris and/or organisms clogging the filter screen. Depending on the water body conditions and the volume of debris, a trade off may be found between the use of a forced debris removal mechanism and deliberately allowing some portion of the debris (and therefore some organisms) to become entrained. These aspects commensurately affect the organism lethality and the ultimate design and performance of the process plant.

Water discharged from process plant will generally possess a different temperature, salinity, chemical composition, or other property compared to the water body. The lethality of such water property differences in the initial discharge zone is often reduced by simply diluting the effluent with a large volume of water from the commensurate intake whilst discharging it at one location. Such systems naturally require a larger volume of intake water, thereby potentially increasing the volume of entrained or impinged organisms.

Alternatively, the undiluted effluent can be dispersed over a sufficiently large water body area so that water body cross currents are able to mix with the effluent quickly enough to sufficiently reduce the water property lethality.

### SUMMARY OF THE INVENTION

The present invention relates to the use of porous pipe manufactured according to U.S. patent application Ser. No. 15/552,868, filed Aug. 23, 2017, which is a U.S. National Stage Entry of International Application No. PCT/US16/19068 filed Feb. 23, 2016, which claims the benefit of U.S. Provisional Application No. 62/119,497 filed Feb. 23, 2015, each of which are incorporated by reference in their entirety. Such porous pipe exhibits a plurality of pores perforating the pipe wall over the entire active surface area of a variable and accurately manufactured diameter and distribution henceforth referred to as the amount of porosity at a location on the pipe.

A porous pipe is generally situated at or under the bed of the water body with an end affixed to conventional plant intake or discharge pipework.

The present applications relates to the novel configuration of the aforementioned porous pipe in offshore water intake and discharge structures in replacement of, or in addition to, traditional fine and/or coarse filters to eliminate entrapment and reduce debris and organism entrainment and impingement; the method of calculating manufacturing parameters to achieve an optimum amount of porosity at any location along the porous pipe; the novel application of varying the pore diameter and distribution along the porous pipe and thereby along the intake structure; the novel methods of porous pipe maintenance and debris removal; and to the methods of such porous pipe installation.

In accordance with the first aspect of the invention, a negative pressure at the conventional plant pipework relative to the water body will cause water to enter the porous pipe throughout all of the pores distributed along the whole of the porous pipe. A positive relative pressure will cause process water to discharge throughout the pores.

In further accordance with the first aspect of the invention, the plurality of small diameter pores, typically in the order of 1 mm or less, in close proximity throughout the entire surface area of the porous pipe wall, enable the porous pipe wall to act as a fine filter with impingement characteristics exceeding commonly used fine filters. Conversely, the pipe wall can be manufactured to possess a strength and durability comparable to that exhibited by common coarse filters.

In further accordance with the first aspect of the invention, the novel practicability of distributing small diameter pores over a large area, and thereby creating a filter with a large surface area, enables a large volume flow-rate of water, spread over a sufficiently large area, to flow at an average intake velocity well below that of comparable current intake structures offering much improved impingement characteristics over current structures. Moreover, reducing the average intake velocity to below the average particle settling velocity at the structure will furthermore reduce entrainment and subsequent clogging of the pores by particles of comparable size, such as sand.

In locating the fine filter within the general water body, rather than as is currently usual practice some distance downstream of pipework such as in a forebay area, entrapment of organisms and debris is effectively removed in accordance with the first aspect of the invention. The process plant, which would usually only require a coarse filter, may easily utilize the porous pipe in place of the coarse filter offering massively improved entrainment characteristics compared to current common input structures.

The design and operating characteristics of a porous pipe are able to be optimized for any particular application. In accordance with a second aspect of the present invention, a method to calculate the optimum amount of porosity at a given location or section of the pipe to achieve given operational characteristics has been derived and is provided. The method further generates various manufacturing parameters in accordance with the aforementioned referenced patent. The general method and details have been outlined below.

In accordance with a third aspect of the invention, the diameter, length, and distribution of pores may be varied along the length of the pipe. Implementing this novel method not only allows accurate control over the volume flow-rate and fluid velocity through the porous pipe pores at any location along the pipe, but also allows a practicable reduction of intake water velocity. Moreover, the novel method also allows discharge water to be distributed in a predetermined controlled fashion.

In accordance with a fourth aspect of the present invention, a method to remove foreign matter from a pore is provided. It is envisaged that, even at low water velocities, drawing water carrying suspended solids through pores of comparable diameter to the particles will clog pores over time, as is currently the case. Henceforth, filters are currently periodically cleaned using a variety of active and passive techniques as previously described. A novel method of sonic cleansing is implemented to remove the need for mechanical cleaning and/or regular intervention. The porous pipe wall is vibrated using piezoelectric actuators or other similar devices located periodically or strategically, which require no maintenance throughout the porous pipe lifetime. Such vibrations may be applied continuously or periodically, and at a frequency or frequencies suited for the particular installation. Vibration of the pipe wall will cause an entrenched particle to be dislodged, and ultimately removed from the pore.

In accordance to the fifth aspect of the present invention, the pipe may be manufactured in one or more sections of any given length as is practicable for a particular installation. Depending on the site, the installation method may include towing a single piece from shore whilst causing it to float through inflation with an air supply, or threading a porous pipe into another pipe, porous pipe, or general enclosure.

According to an embodiment of the present application, a pipe is provided comprising a plurality of pores arranged along a length of the pipe disposed in a body of a liquid; and a pipe discharge end configured to be connected to a negative pressure source; wherein the negative pressure source is configured to cause the liquid to be drawn into the plurality of pores arranged along the length of the pipe and delivered to the negative pressure source; and wherein the plurality of pores are configured to filter particulates from entering along the length of the pipe. The plurality of pores arranged along the length of the pipe may comprise one or more pores of a first diameter and one or more pores of at least a second diameter. The plurality of pores comprises spacing between each pore, and the size of the spacing may change in different sections of the pipe. The pipe comprises a pipe wall having the plurality of pores formed therethrough, and the thickness of the pipe wall may change in different sections of the pipe. The diameter of the pipe wall may also change in different sections of the pipe. In additional embodiments, the pipe may further comprise an inner pipe wall comprising a further plurality of pores arranged along the inner pipe wall, wherein the inner pipe wall is suspended from inside the pipe wall. In still further embodiments of the pipe, the pipe further comprises at least one piezoelectric vibrational device affixed to the pipe wall and connected to an electrical cable. The at least one piezoelectric vibrational device may comprise an actuator connected to the pipe wall on a first end and connected to a counterweight on a second end and an alternating voltage is supplied to the actuator by the electrical cable causing the pipe wall to vibrate and dislodge debris in the plurality of pores.

According to an embodiment of the present application, a pipe is provided comprising a plurality of pores arranged along a length of the pipe disposed in a body of a first liquid; and a pipe intake end configured to be connected to a positive pressure source providing a second liquid; wherein the positive pressure source is configured to cause the second liquid to be drawn into the pipe and discharged through the plurality of pores arranged along the length of the pipe; and wherein the plurality of pores are configured to filter particulates from the second liquid from being discharged into the body of the first liquid along the length of the pipe. The plurality of pores arranged along the length of the pipe may comprise one or more pores of a first diameter and one or more pores of at least a second diameter. The plurality of pores comprises spacing between each pore, and the size of the spacing may change in different sections of the pipe. The pipe comprises a pipe wall having the plurality of pores formed therethrough, and the thickness of the pipe wall may change in different sections of the pipe. The diameter of the pipe wall may also change in different sections of the pipe. In additional embodiments, the pipe may further comprise an inner pipe wall comprising a further plurality of pores arranged along the inner pipe wall, wherein the inner pipe wall is suspended from inside the pipe wall. In still further embodiments of the pipe, the pipe further comprises at least one piezoelectric vibrational device affixed to the pipe wall and connected to an electrical cable. The at least one piezoelectric vibrational device may comprise an actuator connected to the pipe wall on a first end and connected to a counterweight on a second end and an alternating voltage is supplied to the actuator by the electrical cable causing the pipe wall to vibrate and dislodge debris in the plurality of pores.

In accordance with a further embodiment of the application, a method for designing and manufacturing a porous pipe is provided, comprising: dividing the porous pipe into a plurality of elements of a predefined length and diameter; assigning a material of known permeability to each of the plurality of elements for manufacture of each of the plurality of elements; determining, for a first element of the plurality of elements, a required flow rate for a first end of the first element; determining, based at least partly on the required flow rate for the first end of the first element and the known permeability of the material of the first element, a pore flow rate for a single idealized pore of the first element; determining, based on the required flow rate for the first end of the first element and the pore flow rate for the first element, an end flow rate for a second end of the first element; iterating the steps of determining the required flow rate, the pore flow rate and the end flow rate for each of the plurality of elements, wherein for each element after the first element, the required flow rate of the first end of each element is the end flow rate for the second end of the prior element; determining, based on the iterations for each of the plurality of the elements of the porous pipe, a total flow rate the porous pipe may tolerate in a fluid body; and manufacturing the porous pipe having the plurality of elements, each having their respective predefined lengths and diameters and materials.

In accordance with various embodiments of the method, the required flow rate for the first end of the first element corresponds to an intake flow rate of a fluid intake to which the porous pipe is to be connected, or a discharge flow rate of a fluid discharge to which the porous pipe is to be connected. Each of the plurality of elements may further comprise one or more of a predefined wall thickness, pore distribution or pore diameter.

In accordance with a further embodiment of the method, the method further comprises: prior to manufacturing the porous pipe, redefining one or more of the predefined length, diameter, wall thickness, pore distribution or pore diameter of one or more of the plurality of elements, or assigning a new material having a different permeability to one or more of the plurality of elements, to provide one or more of the plurality of elements with redefined parameters; and repeating the steps of determining a required flow rate for a first end of the first element, determining the pore flow rate for the first element, determining the end flow rate for the second end of the first element and iterating the steps of determining for each of the plurality of elements of the porous pipe based on the redefined parameters, and determining a new total flow rate the porous pipe may tolerate in the fluid body. Providing one or more of the plurality of elements with redefined parameters is repeated until a target total flow rate the porous pipe may tolerate in the fluid body is reached based on a particular set of redefined parameters for the plurality of elements; and manufacturing the porous pipe further comprises manufacturing the porous pipe in accordance with the particular set of redefined parameters for the plurality of elements.

### BRIEF DESCRIPTION OF THE DRAWINGS

FIG. 1A illustrates some typical arrangements of intake structures and methodologies currently employed according to the prior art;

FIG. 1B illustrates various embodiments of porous pipe configurations in accordance with the present application;

FIG. 2 illustrates a cross-sectional view of an installed porous pipe in accordance with an embodiment of the present application;

FIG. 3 illustrates further cross-sectional views of porous pipe in accordance with an embodiment of the present application;

FIG. 4 illustrates a cross-sectional view of an installed porous pipe in accordance with a further embodiment of the present application;

FIG. 5 illustrates a finite element of the porous pipe as used in the finite element analysis model; and

FIGS. 6A-6C illustrate various embodiments of porous pipe configurations in accordance with the present application comprising piezoelectric vibrational devices to perform a vibrational cleansing method of the pores.

### DETAILED DESCRIPTION OF THE DRAWINGS

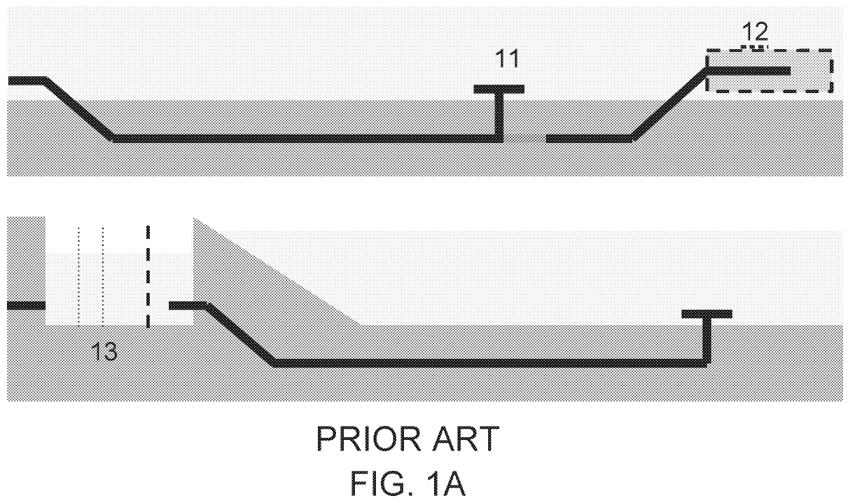

The present application will now be described with reference made to FIGS. 1B to 6C.

Porous pipe enables a cost effective structure to be employed that acts to strain filter water directly within the water body, efficiently removing organism entrapment, and significantly reducing entrainment and impingement. These functions can be performed by varying various features of the pipe wall, including: pore distribution can be controlled and varied along the pipe such that the average approach water velocity to the pipe surface (i.e., the actual water intake flow) is lower than the local particle settling velocity, and far lower than the local organism impingement velocity; pore diameter can also be controlled and varied along the pipe to limit the maximum particle diameter that may be entrained and locating the fine filtration within the water body removes organism entrapment; the wall thickness can be controlled and varied along the pipe to achieve the required pipe wall strength, and vary the pore length, thereby varying the flow resistance; and vibrating the pipe wall at frequencies optimized to remove impinged debris from pores.

In accordance with the present application, the porous pipe 101a, 101b, 101c may be manufactured to any length with an end jointed to conventional plant pipework 102a, 102b, 102c, as shown in FIG. 1B. In one example shown at the top of FIG. 1B, the porous pipe 101a wall may be manufactured at a thickness and strength suitable to be located any distance 103d from the water body bed 103 or any distance 104d from the surface 104. The porous pipe 101b, 101c may also be fully or partially contained in a further porous pipe, protective structure 105, trench 106 or other enclosure allowing communication between the porous pipe and the water body, as illustrated in the center and bottom of FIG. 1B. The installed porous pipe 101c may undergo variations in direction and depth 107 as required in the specific application and permitted by its manufacture.

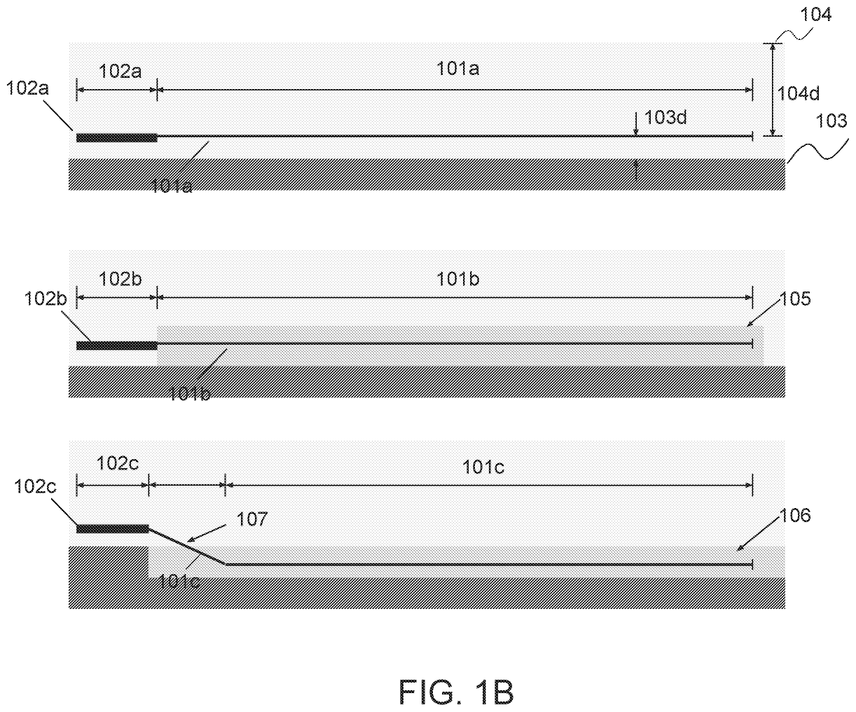

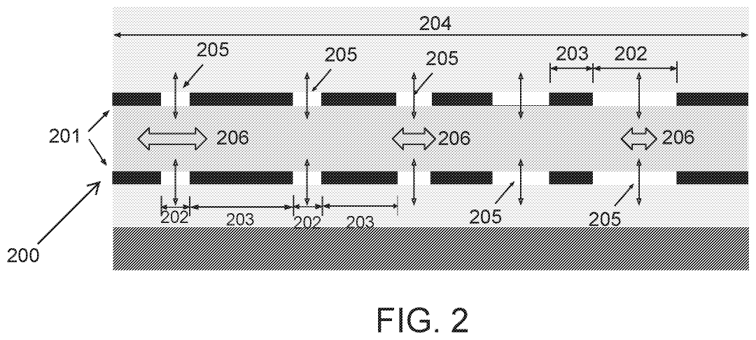

FIGS. 2 and 3 illustrate cross-sectional views of a porous pipe 200. The walls 201 of the porous pipe 200 can be manufactured according to the processes and comprise the materials described in the aforementioned referenced U.S. patent application Ser. No. 15/552,868, thereby expressing a plurality of pores 205 throughout the entire wall 201 surface area of the pipe 205. The walls 201 are manufactured at a suitable thickness 201a, 201b, which may vary along the length 204 of the pipe 200, and local wall thickness variations may occur, for example at sectional joints. The porous pipe walls 201 form a circular or other shaped profile that may also change in diameter 202a, 202b along the length 204 of the porous pipe 200.

In further accordance with the present application, the diameter 202 of each pore 205, and the spacing 203 between pores 205 can be varied along the length 204 of the pipe 200 as required to create a given porosity. The pressure difference along a pore (i.e., across the pipe wall 201), the diameter 202 of the pore, and other structural compositions (e.g., pore pathway between weave layers) determine the water volume flow rate through a pore 205. Each pore 205 can be maintained at a suitable velocity and jet diameter 202 to reduce impingement and entrainment. The pressure gradient 206 along the pipe 200 may change commensurately, thereby varying the pressure difference 206 at each pore 205.

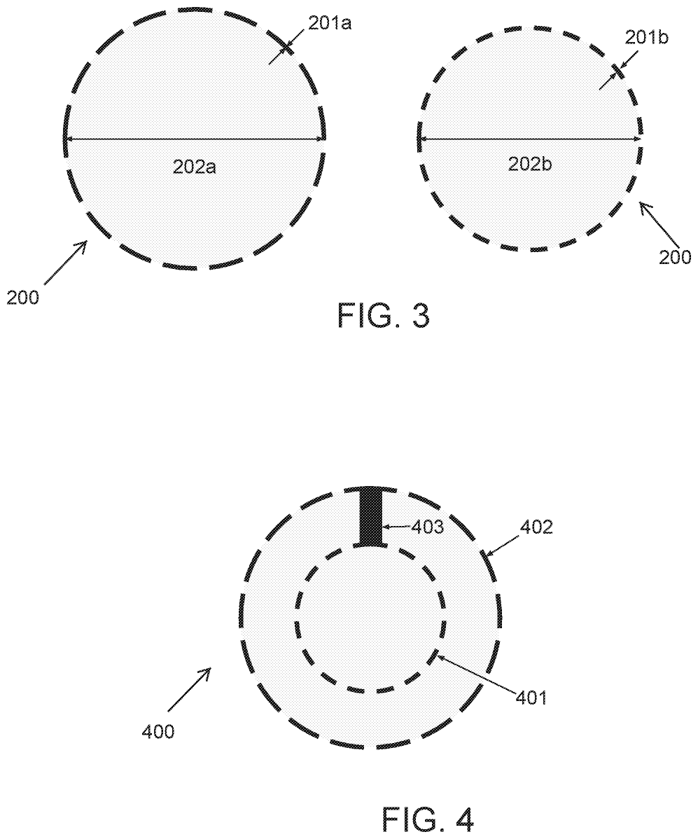

In a further embodiment shown in FIG. 4, the porous pipe 400 may additionally be configured with multiple walls 401, 402 having different diameters and different amounts of porosity, and with one or more of such walls 401, 402 configured incorporating structural elements. For such “pipe in pipe” configurations 400, the inner pipe 401 may be suspended 403 from or otherwise supported by the outer pipe 402, such that sonic or other type of cleaning of the inner and outer pipes 401, 402 may be readily undertaken.

Given required flow conditions, for example a process plant intake flow-rate, the present application allows the design of the porous pipe to be changed and variable to optimize performance of the porous pipe. A process plant typically requires a known and steady flow-rate, and is often able to adjust its intake and discharge pressures within a specified range to achieve this desired operating envelope.

The pipe can be designed by the user by dividing the pipe into sections of known properties (e.g. length, depth, etc.), and assigning a material of known permeability to each section. An effectively unlimited number of section and material combinations may be used. The permeability of a material of known construction is derived through a mixture of calculations and, to ensure accuracy, empirical testing. The depth at the start and end of each section can be used to determine the water body pressure of an undulating pipe.

Various manufacturing parameters of the porous pipe material that affect flow characteristics within a particular operating environment can be controlled. The value of these parameters (and thereby the permeability) can therefore change along the length of the pipe and include, but are not limited to, length, diameter, wall thickness, pore distribution, pore diameter, direction, etc. With knowledge of the particular configurations of these manufacturing parameters, and the resulting permeabilities, the expected flow characteristics of the porous pipe can be calculated.

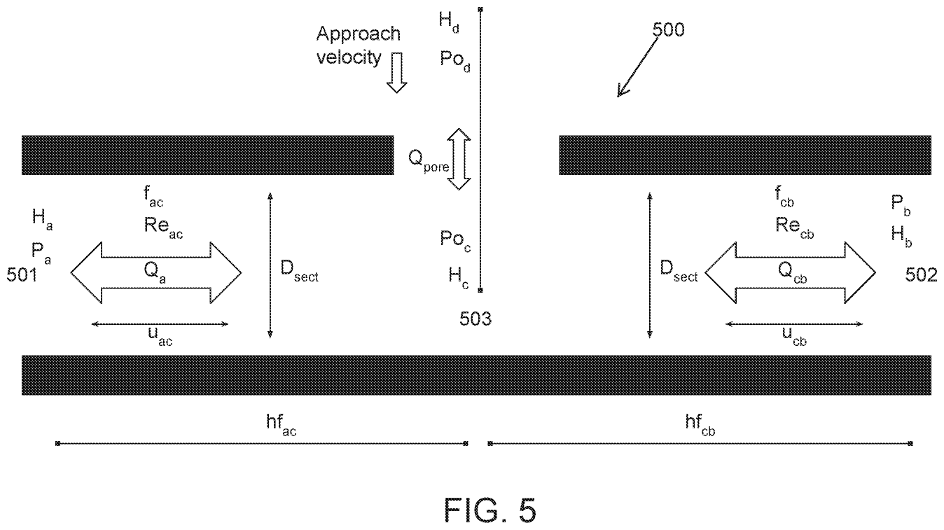

The porous pipe is divided into discrete elements suitable for Finite Element Analysis (“FEA”). It is impractical to model every pore on the entire pipe, therefore each element models the element's plurality of pores as a single pore with a short length of non-porous pipe at either side. By reducing the total length of each element, and thereby increasing the number of elements, the accuracy of the calculation can be increased. The total volume flow-rate through the pores of each element is calculated using the idealized single pore and the number of pores dispersed along the circumference and length of the element (and, thereby, the entire porous pipe). Calculated volume flow-rates and the flow characteristics through each element are consequently based on this model. In the present application and shown for example in FIG. 5, elements are referred to as end “a” (the shorewards end), end “b” (the seawards end), point “c” (the modelled pore), and point “d” (the water body immediately next to point c). The pipe may have multiple sections, and each section may have multiple elements.

Calculation Parameters

The following input, intermediate calculation, and output parameters are ostensibly specified in SI units (indicated in brackets below); however another system may be supplanted if desired.

1. Input Parameters
Qₚᵢₚₑ [m³/s] Volume flow-rate through the porous pipe and thereby to pass through the pores.
Pₚᵢₚₑ [N/m²] Porous pipe pressure at the process pipework connection.
Pₐᵢᵣ [N/m²] Absolute air pressure at the water body surface.
Z_{sect} [m] Depth at seaward and shoreward ends of each section.
μ [N·s/m] Average dynamic viscosity of the pipe and water body fluid.
ρ [kg/m³] Average density of the pipe and water body fluid.
t_{wall} [m] Porous pipe wall thickness (may be a function of location).
ϵₚᵢₚₑ [m] Roughness of porous pipe wall internal surface.

2. Intermediate Calculation Parameters
D_{sect} [m] Diameter of a section (assumed to be constant for the section).
L_{sect} [m] Length of a section.
n Number of elements in a section.
L_{ab} [m] Length of an element.
Hₐ, H_{b} [m] Water head at element ends a and b.

Pₐ, P_{b} [N/m²] Dynamic pressure at element ends a and b.

Po_{c}, Po_{d} [N/m²] Static pressure at element modelled pore point c and water body point d.
u_{ac}, u_{cb} [m/s] Fluid velocity element end a to point c, and point c to end b.
Re_{ac}, Re_{cb} [m/s] Commensurate Reynolds number element end a to point c, and point c to end b.
f_{ac}, f_{cb} [m/s] Commensurate friction factor element end a to point c, and point c to end b.
hf_{ac}, hf_{cb} [m/s] Commensurate frictional loss end a to point c, and point c to end b.
V_{ac}, V_{cd}, V_{cb} Volume flowrate element ends a and b, and modelled pore point c and water body point d.

3. Output Parameters
Lₚᵢₚₑ [m] Required length of the designed porous pipe to operate at the given flow envelope.
Qₚₒᵣₑₛ [m] Volume flowrate out of the pores of a section of pipe.
Material_{dist} The material construction used at any given distance along the pipe.
Permeability_{dist} The resulting permeability at any given distance along the pipe.

Detailed Calculations

The design and method of manufacture provided for in U.S. patent application Ser. No. 15/552,868 allows for the distribution and dimension of pores to be accurately controlled, thereby controlling the amount of porosity and overall water flow-rate through the pipe wall at any given location. Subsequently, in accordance with the second aspect of the invention, a method has been provided to determine the optimum manufacturing parameters and design for the porous pipe given a demanded discharge or intake volume flow-rate. The calculations can be performed by a computer processor executing instructions comprising the algorithms for performing the calculations, such as by executing a software program stored on a tangible computer readable medium, which executes a number of iterative loops using a computer processor. The calculation steps will now be described with reference to FIG. 5, which shows an example of an element 500.

As discussed previously, an accurate permeability of a material, given in volume flowrate per area per pressure difference with material thickness, is derived through empirical means. An empirical permeability value is only valid for the pressure differences and material thicknesses that it has been tested with. Therefore, such values are monitored and only valid materials are allowed to be used for a section.

The fluid velocity (u_{ac}) through the first half of the element length is calculated from the average element diameter (D_{sect}) and required volume flow-rate (Q_{ac} or Qₐ) (1).

$${Q}_{a c} = {u}_{a c} \times \frac{{D}_{sect}^{2}}{4} \qquad ( 1 )$$

Flow conditions at an end 501 of the element 500 (end “a”) determine the relevant head Hₐ using Bernoulli's equation (2), and Reynold's equation (3) assuming a fully developed flow.

$$\begin{matrix}{H}_{a} = \frac{{P}_{a}}{ρ g} + \frac{{u}_{a c}^{2}}{2 g} + {z}_{a} & ( 2 ) \\ R {e}_{a c} = \frac{ρ \times {u}_{a c} \times {D}_{sect}}{μ} & ( 3 )\end{matrix}$$

The average Reynold's number over the first half of the element 500 with the Colebrook-White equation (4) and material roughness is used to determine the relevant Darcy friction factor.

$$\frac{1}{\sqrt{{f}_{a c }}} = - 0.8 \; 69 ln ( \frac{ϵ}{3.7 {D}_{sect}} + \frac{2.523}{R {e}_{a c} \sqrt{{f}_{a c}}} ) \qquad ( 4 )$$

The Darcy-Weisbach equation (5) is subsequently used to calculate the head loss (hf_{ac}) over the first half of the element 500, and thereby the remaining head (H_{c}) at a location with a pore in the element 503 (“c”), typically half-way between ends 501 (“a”) and 502 (“b”)

$${H}_{c} = {H}_{a} - Δ h {f}_{a c} = {H}_{a} - {f}_{a c} \frac{{L}_{a c}}{{D}_{se ct}} \frac{{u}_{a c}^{2}}{2 g} \qquad ( 5 )$$

The difference in pipe static pressure (6) and water body static pressure (7), with the material permeability, thickness, and elemental surface area, allows calculation of the volume flowrate through the pores of the element 500 (8).

Po_{c}=H_{c}×gρ (6)

Po_{d}=depth_{d}×gρ (7)

Qₚₒᵣₑₛ=Permeability_{wall}×(Po_{c}−Po_{d})×(π×D_{sect})×L_{ab}÷t_{wall} (8)

The volume flowrate (Q_{b} or Q_{cb}) at the other end 502 of the element 500 is given by the continuity equation (9), thereby allowing the head (H_{b}) to be derived which forms the input for the next element.

Qₐ−Qₚₒᵣₑₛ=Q_{b} (9)

The results of the calculation for each element 500 can be congregated, thereby calculating the total flow-rate (Qₚᵢₚₑ) that a porous pipe of the specified dimensions may tolerate at a designated positive or negative pressure difference with the water body.

By iteratively changing any of the aforementioned porous pipe design parameters and materials selection, and recalculating the resulting flow characteristics, the porous pipe design can be optimized for an installation's required process flow.

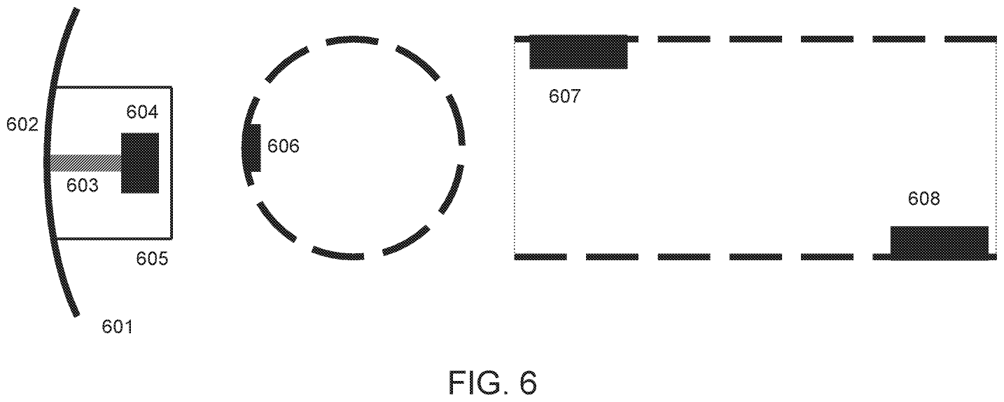

In additional embodiments of the present application, shown for example in FIGS. 6A-6C, one or more piezoelectric vibrational devices 601 can be affixed directly to the porous pipe wall 602. A piezoelectric actuator 603 connects the inner or outer surface of the porous pipe wall 602 to a counterweight 604, with the entire structure of the piezoelectric vibrational device 601 protected by a permanent watertight cover 605. An alternating voltage supplied by an electrical cable encased within a duct or within the pipe matrix is applied to the piezoelectric actuator 603 causing the piezoelectric actuator 603 to expand and contract at a commensurate frequency.

Consequently, coupled with the counterweight 604, a cyclical force is applied to the pipe wall 602. The pipe wall 602 stiffness is high and known, such that the pipe may vibrate at a fundamental frequency, thus maximizing the effect of cleaning and removing debris from the pores. The piezoelectric devices 601 can be located periodically or strategically along the length pipe and at any orientation, as shown for example in FIGS. 6B and 6C.

In summary, the present application relates to an intake or discharge structure commonly used to transfer water between process pipework and a general water body, such as a lake or sea, including, but not limited to, the following: an applicable intake or discharge structure comprising a novel design of porous pipe laid on, near, or under the seabed, or generally submerged within the body of water; the use of a plurality of pores throughout the full surface area of the porous pipe wall through which water will flow; the use of pores accurately manufactured in diameter and length such that the amount of porosity at any location of the porous pipe wall can be controlled; an application of varying the amount of porosity along the length of the pipe; a structure comprising such a porous pipe acting to distribute discharged water over an area; an application of filtering water to a fine degree of filtration along the whole length of the porous pipe directly within the water body; an ability to reduce the intake velocity of water from the immediate water body to velocities far below those currently generally seen; an intake structure with an intake velocity below the settling velocity of particulates within the water body; and a unique method of applying high frequency vibration to the porous pipe wall to dislodge particulates that have become embedded within pores.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale or orientation.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

1. A pipe comprising:
a plurality of pores arranged along a length of the pipe disposed in a body of a liquid; and
a pipe discharge end configured to be connected to a negative pressure source;
wherein the negative pressure source is configured to cause the liquid to be drawn into the plurality of pores arranged along the length of the pipe and delivered to the negative pressure source; and
wherein the plurality of pores are configured to filter particulates from entering along the length of the pipe.

2. The pipe according to claim 1, wherein the plurality of pores arranged along the length of the pipe comprise one or more pores of a first diameter and one or more pores of at least a second diameter.

3. The pipe according to claim 1, wherein the plurality of pores comprises spacing between each pore, and wherein the size of the spacing changes in different sections of the pipe.

4. The pipe according to claim 1, wherein the pipe comprises a pipe wall having the plurality of pores formed therethrough, and wherein the thickness of the pipe wall changes in different sections of the pipe.

5. The pipe according to claim 4, wherein the diameter of the pipe wall changes in different sections of the pipe.

6. The pipe according to claim 4, further comprising an inner pipe wall comprising a further plurality of pores arranged along the inner pipe wall, wherein the inner pipe wall is suspended from inside the pipe wall.

7. (canceled)

8. The pipe according to claim 4, further comprising at least one piezoelectric vibrational device affixed to the pipe wall and connected to an electrical cable, wherein the at least one piezoelectric vibrational device comprises an actuator connected to the pipe wall on a first end and connected to a counterweight on a second end; and
wherein an alternating voltage is supplied to the actuator by the electrical cable causing the pipe wall to vibrate and dislodge debris in the plurality of pores.

9. A pipe comprising:
a plurality of pores arranged along a length of the pipe disposed in a body of a first liquid; and
a pipe intake end configured to be connected to a positive pressure source providing a second liquid;
wherein the positive pressure source is configured to cause the second liquid to be drawn into the pipe and discharged through the plurality of pores arranged along the length of the pipe; and
wherein the plurality of pores are configured to filter particulates from the second liquid from being discharged into the body of the first liquid along the length of the pipe.

10. The pipe according to claim 9, wherein the plurality of pores arranged along the length of the pipe comprise one or more pores of a first diameter and one or more pores of at least a second diameter.

11. The pipe according to claim 9, wherein the plurality of pores comprises spacing between each pore, and wherein the size of the spacing changes in different sections of the pipe.

12. The pipe according to claim 9, wherein the pipe comprises a pipe wall having the plurality of pores formed therethrough, and wherein the thickness of the pipe wall changes in different sections of the pipe, and wherein the diameter of the pipe wall changes in different sections of the pipe.

13. (canceled)

14. The pipe according to claim 12, further comprising an inner pipe wall comprising a further plurality of pores arranged along the inner pipe wall, wherein the inner pipe wall is suspended from inside the pipe wall.

15. (canceled)

16. The pipe according to claim 12, further comprising at least one piezoelectric vibrational device affixed to the pipe wall and connected to an electrical cable, wherein the at least one piezoelectric vibrational device comprises an actuator connected to the pipe wall on a first end and connected to a counterweight on a second end; and
wherein an alternating voltage is supplied to the actuator by the electrical cable causing the pipe wall to vibrate and dislodge debris in the plurality of pores.

17. A method for designing and manufacturing a porous pipe, comprising:
dividing the porous pipe into a plurality of elements of a predefined length and diameter;
assigning a material of known permeability to each of the plurality of elements for manufacture of each of the plurality of elements;
determining, for a first element of the plurality of elements, a required flow rate for a first end of the first element;
determining, based at least partly on the required flow rate for the first end of the first element and the known permeability of the material of the first element, a pore flow rate for a single idealized pore of the first element;
determining, based on the required flow rate for the first end of the first element and the pore flow rate for the first element, an end flow rate for a second end of the first element;
iterating the steps of determining the required flow rate, the pore flow rate and the end flow rate for each of the plurality of elements, wherein for each element after the first element, the required flow rate of the first end of each element is the end flow rate for the second end of the prior element;
determining, based on the iterations for each of the plurality of the elements of the porous pipe, a total flow rate the porous pipe may tolerate in a fluid body; and
manufacturing the porous pipe having the plurality of elements, each having their respective predefined lengths and diameters and materials.

18. The method according to claim 17, wherein the required flow rate for the first end of the first element corresponds to an intake flow rate of a fluid intake to which the porous pipe is to be connected, or a discharge flow rate of a fluid discharge to which the porous pipe is to be connected.

19. (canceled)

20. The method according to claim 17, wherein the pore flow rate for each element is determined by the equation Qₚₒᵣₑₛ=Permeability_{wall}×(Po_{c}−Po_{d})×(π×D_{sect})×L_{ab}+t_{wall}, wherein
Qₚₒᵣₑₛ is the pore flow rate for the element;
Permeability_{wall} is the known permeability of the material of the element;
Po_{c} is the pipe static pressure;
Po_{d} is the fluid body static pressure;
D_{sect} is the predefined diameter of the element;
L_{ab} is the predefined length of the element; and
t_{wall} is the predefined wall thickness of the element.

21. The method according to claim 20, wherein the pipe static pressure (Po_{c}) is determined by the equation Po_{c}=H_{c}×gρ, wherein
H_{c} is the fluid head at the idealized pore of the element; and
ρ is the average density of fluid in the porous pipe.

22. The method according to claim 20, wherein the fluid body static pressure (Po_{d}) is determined by the equation Po_{d}=depth_{d}×gρ, wherein depth_{d} is the depth at a point of the fluid body adjacent to the idealized pore of the element.

23. The method according to claim 20, wherein the end flow rate for the second end of each element is determined by the equation Qₐ−Qₚₒᵣₑₛ=Q_{b}, wherein
Qₐ is the required flow rate for the first end of the element, and
Q_{b} is the end flow rate for the second end of the element.

24. The method according to claim 17, further comprising:
prior to manufacturing the porous pipe, redefining one or more of the predefined length, diameter, wall thickness, pore distribution or pore diameter of one or more of the plurality of elements, or assigning a new material having a different permeability to one or more of the plurality of elements, to provide one or more of the plurality of elements with redefined parameters; and
repeating the steps of determining a required flow rate for a first end of the first element, determining the pore flow rate for the single idealized pore of the first element, determining the end flow rate for the second end of the first element and iterating the steps of determining for each of the plurality of elements of the porous pipe based on the redefined parameters, and determining a new total flow rate the porous pipe may tolerate in the fluid body;
wherein providing one or more of the plurality of elements with redefined parameters is repeated until a target total flow rate the porous pipe may tolerate in the fluid body is reached based on a particular set of redefined parameters for the plurality of elements; and
wherein manufacturing the porous pipe further comprises manufacturing the porous pipe in accordance with the particular set of redefined parameters for the plurality of elements.
